(19) United States
(12) Patent Application Publication
(10) Pub. No.: US 2026/0338703 A1
(43) Pub. Date: Oct. 29, 2026

(54) INSPECTION CONDITION DETERMINATION SYSTEM

(71) Applicant: Hitachi, Ltd., Tokyo (JP)

(72) Inventors: Hiroaki KASAI, Tokyo (JP); Atsushi MIYAMOTO, Tokyo (JP); Mayuka OSAKI, Tokyo (JP)

(73) Assignee: Hitachi, Ltd., Tokyo (JP)

(21) Appl. No.: 19/119,662

(22) PCT Filed: Sep. 20, 2023
(86) PCT No.: PCT/JP2023/034056

§ 371 Date: Apr. 9, 2025

(30) Foreign Application Priority Data
Oct. 11, 2022 (JP) 2022-163558

(51) Int. Cl. G01N 21/88

(52) U.S. Cl. CPC G01N 21/8851; G01N 21/8806

(57) ABSTRACT

A computer comprises a processor and determines the inspection conditions of an inspection system with respect to an inspection object, the processor is configured to: receive at least two element evaluation indexes and a user request pertaining to a target of the element evaluation indexes, the element evaluation indexes including a rate of inspection correct answers, a misinformation rate, an inspection time, inspection reproducibility, a training time, the device cost, the operation cost, the device robustness, versatility of inspection, the lifespan, ease of assembly, accuracy of required assembly, robustness to environment, ease of maintenance, clarity of the grounds of determination of recognition processing, or ease of recognition of detection points; generate evaluation indexes based on the evaluation indexes for the inspection on the basis of the user request; evaluate the inspection result in the plurality of inspection conditions; and determine suitable inspection conditions from the of inspection conditions.

### TECHNICAL FIELD

The present invention relates to a technology of determining an inspection condition in an inspection system for inspecting an inspection object.

### BACKGROUND ART

For example, there is known an inspection system that performs an appearance inspection on a product manufactured in a manufacturing process, and the like.

As a method of setting an inspection condition in an inspection system, Patent Literature 1 discloses a method of setting a lighting condition when inspecting an object, the method comprising: illuminating the object with a light source capable of changing a lighting parameter that specifies the lighting condition when imaging the object, imaging the object with an image sensor using a plurality of lighting parameters, and obtaining a captured image corresponding to the plurality of lighting parameters, the object having a known label data; generating an estimation image of the object when the object is illuminated using a variable lighting parameter based on an image data set obtained by associating the captured image with the lighting parameter corresponding to the captured image; and applying the estimation image corresponding to the variable lighting parameter of the object and the corresponding label data to learning of the machine learning model and setting both the lighting condition of the machine learning model and an inspection algorithm parameter by simultaneously optimizing the lighting parameter and the inspection algorithm parameter based on an estimation result of the machine learning model and a comparison result of the label data of the object.

### CITATION LIST

### Patent Literature

Patent Literature 1: WO 2019/171121

### SUMMARY OF INVENTION

### Technical Problem

The technology described in Patent Literature 1 allows for simultaneously optimizing both the lighting parameter and the parameter of the inspection algorithm taking into consideration only the inspection accuracy.

However, it is not necessarily preferable to determine the condition taking into consideration only the inspection accuracy in an inspection system.

The present invention has been made in the light of the above-mentioned circumstances, and its object is to provide a technology that allows for appropriately determining an inspection condition in an inspection system.

### Solution to Problem

To achieve the above-mentioned object, an inspection condition determination system according to one aspect is an inspection condition determination system that includes a processor and determines an inspection condition in an inspection of a predetermined inspection object in the inspection system, in which the processor receives an input of a customer request regarding at least two or more element evaluation indices among an inspection accuracy, a false defect rate, an inspection time, an inspection repeatability, a learning time, a device cost, an operating cost, a device robustness, an inspection versatility, a longevity, an assemblability, a required assembly accuracy, a robustness against environment, a maintenanceability, a clarity of ground for the judgement of recognition processing, and a recognizability of detected portion, and a target of the element evaluation indices about the inspection in the inspection system, creates an evaluation index based on the plurality of element evaluation indices about the inspection in the inspection system on the basis of the user request, evaluates the inspection result under a plurality of inspection conditions by the evaluation index, and determines an appropriate inspection condition from among the plurality of inspection conditions.

### Advantageous Effects of Invention

According to the present invention, it is possible to appropriately determine an inspection condition in an inspection system.

### BRIEF DESCRIPTION OF DRAWINGS

FIG. 1 is an overall configuration diagram of an inspection system according to an embodiment.

FIG. 2 is a configuration diagram of a computer that determines an inspection condition according to an embodiment.

FIG. 3 illustrates the inspection condition according to an embodiment.

FIG. 4 is a flowchart of a first inspection condition optimization processing according to an embodiment.

FIG. 5 is a flowchart of a second inspection condition optimization processing according to an embodiment.

FIG. 6 is a flowchart of an optical model calibration processing according to an embodiment.

FIG. 7 shows a GUI screen according to an embodiment.

FIG. 8 illustrates the inspection condition when dividing an inspection area according to an embodiment.

FIG. 9 illustrates a change in an inspection image according to an embodiment.

FIG. 10 is a flowchart of an inspection condition redetermination processing according to an embodiment.

FIG. 11 illustrates a manufacturing process according to an embodiment.

### DESCRIPTION OF EMBODIMENTS

Hereinafter, one embodiment will be described with reference to the drawings. It should be noted that the embodiment described below does not limit an invention according to the claims and that all of the elements and combinations thereof described in the embodiment are not necessarily essential.

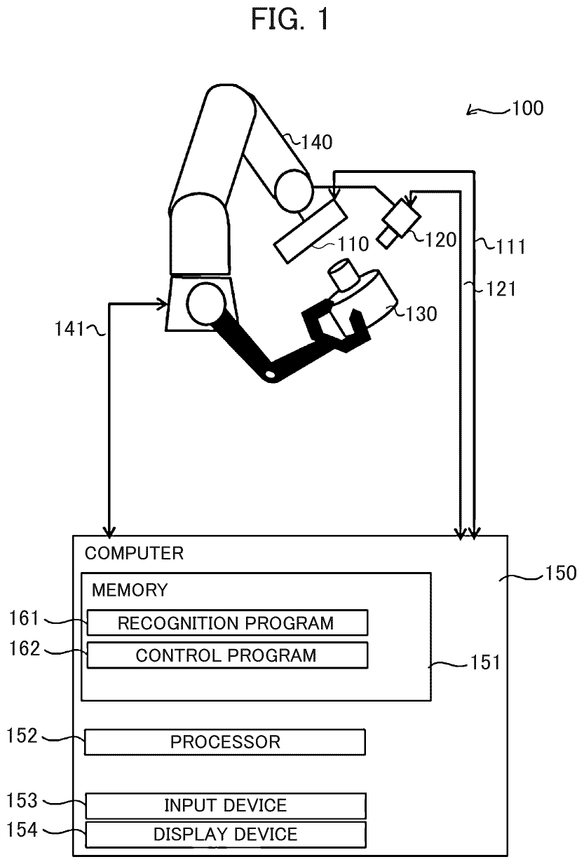

FIG. 1 is an overall configuration diagram of an inspection system according to an first embodiment.

An inspection system 100 includes a lighting 110, an imaging sensor 120, a handling mechanism 140 and a computer 150. The lighting 110 and the computer 150 are connected via a communication line 111, the imaging sensor 120 and the computer 150 are connected via a communication line 121, and the handling mechanism 140 and the computer 150 are connected via a communication line 141.

The lighting 110 emits light for inspection. When an inspection object 130 is irradiated with light from the lighting 110, a defect present on the inspection object 130 can become apparent.

The imaging sensor 120 is a two-dimensional camera or the like that takes an image (digital image) of the inspection object 130. The imaging sensor 120 can image the defect present on the inspection object 130.

The handling mechanism 140 changes relative positions of the lighting 110 and the imaging sensor 120 with respect to the inspection object 130. The handling mechanism 140 is capable of moving either the lighting 110 and the imaging sensor 120 or the inspection object 130 or both.

The computer 150 includes a memory 151, a processor 152, an input device 153 and a display device 154.

The memory 151 is a storage device that stores therein various types of information. The memory 151 may be a non-volatile or volatile memory medium such as, for example, a RAM (Random Access Memory) or a ROM (Read Only Memory). Moreover, the memory 151 may be a rewritable storage medium such as, for example, a flash memory, a hard disk, or an SSD (Solid State Drive), or may be a USB (Universal Serial Bus) memory, a memory card, or the like.

The memory 151 stores therein a recognition program 161 and a control program 162. By being executed by the processor 152, the recognition program 161 performs a processing (recognition processing) for recognizing a defect from the image (digital data) taken by the imaging sensor 120. In the present embodiment, the recognition program 161 is capable of changing at least part of a recognition engine that executes the recognition processing and parameters used for the recognition processing. The control program 162 controls the lighting 110, the imaging sensor 120, and the handling mechanism 140 according to an inspection condition by being executed by the processor 152.

The processor 152 performs various types of processing according to the program stored in the memory 151. The processor 152 may be, for example, a microprocessor, a CPU (Central Processing Unit), a GPU (Graphics Processing Unit), an FPGA (Field Programmable Gate Array), a quantum processor, or another semiconductor device capable of performing an arithmetic operation.

The input device 153 is, for example, a mouse, a keyboard, or the like, and receives an input of information from a user. The display device 154 is, for example, a display, and displays a user interface that includes various types of information.

In the inspection system 100, it is possible to change at least some of a condition of lighting by the lighting 110 (lighting condition), a condition of imaging by the imaging sensor 120 (imaging condition), and a condition of an operation of the handling mechanism 140 (handling condition) as an inspection condition. The lighting condition includes, for example, at least one of lighting type, lighting arrangement, lighting intensity, lighting time, and lighting cycle. The imaging condition includes at least one of imaging sensor type, imaging sensor arrangement, diaphragm amount, imaging time, and imaging cycle. The handling condition includes at least one of a type of the handling mechanism, a position and posture, and a trajectory to the target position and posture.

Next, a computer 200 that performs a processing of determining an optimal inspection condition in the inspection system 100 is described.

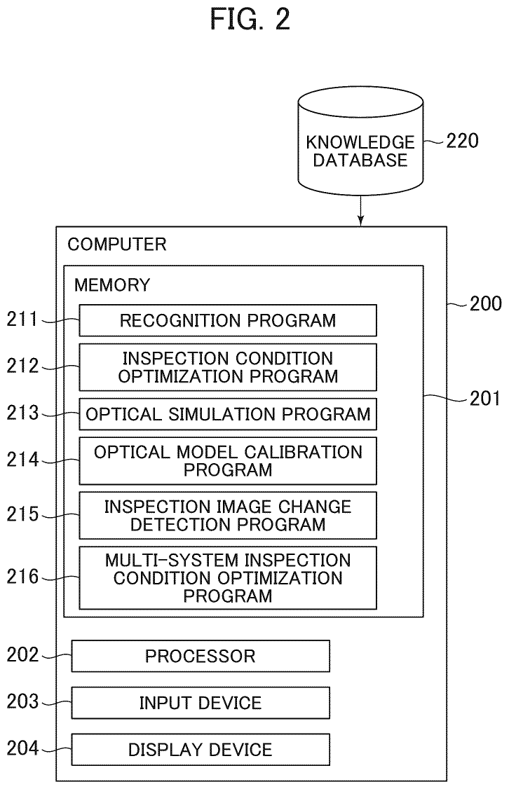

FIG. 2 is a configuration diagram of a computer that determines an inspection condition according to an embodiment.

The computer 200 is an example of an inspection condition determination system, and includes a memory 201, a processor 202, an input device 203, and a display device 204. The computer 200 is connected to a knowledge database 220 via a communication path. The computer 200 according to the present embodiment can obtain an inspection image from the computer 150 and transmit an inspection condition to the computer 150.

The memory 201 is a storage device that stores therein various types of information. The memory 201 may be a non-volatile or volatile memory medium such as, for example, a RAM or a ROM. Moreover, the memory 201 may be a rewritable storage medium such as, for example, a flash memory, a hard disk, or an SSD, or may be a USB memory, a memory card, or the like.

The memory 201 stores therein a recognition program 211, an inspection condition optimization program 212, an optical simulation program 213, an optical model calibration program 214, an inspection image change detection program 215, and a multi-system inspection condition optimization program 216.

The recognition program 211 performs, by being executed by the processor 202, a processing of recognizing a defect from the inspection image. The inspection condition optimization program 212 performs, by being executed by the processor 202, a processing of receiving a request for an inspection from a user (customer) (customer request: user request) and detecting an optimal inspection condition that satisfies the customer request (inspection condition optimization processing). The optical simulation program 213 performs, by being executed by the processor 202, a simulation of the inspection using an optical model capable of reproducing an inspection state of an inspection object in the inspection system 100. The optical model calibration program 214 performs, by being executed by the processor 202, a processing of calibrating the optical model (optical model calibration processing). The inspection image change detection program 215 performs, by being executed by the processor 202, a processing of detecting a change in the inspection image. The multi-system inspection condition optimization program 216 performs, by being executed by the processor 202, a process of determining the optimal inspection condition in the manufacturing process that uses a plurality of inspection systems.

The processor 202 performs various types of processing according to the program stored in the memory 201. The processor 202 may be, for example, a microprocessor, a CPU, a GPU, an FPGA, a quantum processor, or another semiconductor device capable of performing an arithmetic operation.

The input device 203 is, for example, a mouse, a keyboard, or the like, and receives an input of information from a user. The display device 204 is, for example, a display, and displays a user interface that includes various types of information.

The knowledge database 220 manages information about an instance inspected by the inspection system 100, for example, information including an image of the inspection object (inspection image) and an inspection condition at the time, and the like. It should be noted that, although the knowledge database 220 is provided outside the computer 200, the present invention is not limited thereto and the knowledge database 220 may be provided inside the computer 200.

Next, a customer request received by the inspection condition optimization program 212 is described.

The customer request includes a plurality of element evaluation indices including an inspection accuracy f1, a false defect rate f2, an inspection time f3, an inspection repeatability f4, a learning time f5, a device cost f6, an operating cost f7, a device robustness f8, an inspection versatility f9, a longevity f10, an assemblability f11, a required assembly accuracy f12, a robustness against environment f13, a maintenanceability f14, a clarity of ground for the judgement of recognition processing f15, and a recognizability of detected portion f16.

The inspection accuracy f1 is a rate of the correct recognition between the quality product and the defective product with respect to the number of inspection objects. Here, assuming the number of quality products recognized as quality products being TN, the number of defective products recognized as defective products being TP, the number of quality products incorrectly recognized as defective products being FP, and the number of defective products incorrectly recognized as quality products being FN, the inspection accuracy f1 can be represented by Formula (1) described below.

$$\begin{matrix}[ Formula 1 ] & \\ f 1 = \frac{TN + TP}{TP + FP + FN + TN} & ( 1 )\end{matrix}$$

The false defect rate f2 is a rate of quality products being misrecognized as defective products with respect to the total number of quality products. The false defect rate f2 can be represented as Formula (2) described below.

$$\begin{matrix}[ Formula 2 ] & \\ f 2 = \frac{FP}{FP + TN} & ( 2 )\end{matrix}$$

Here, although the inspection accuracy f1 and the false defect rate f2 are given as examples of indications of an inspection accuracy, the indications are not limited thereto and other indications may be used that use more than one of TN, TP, FP, and FN.

The inspection time f3 is time regarding the inspection, and may be, for example, moving time of the handling mechanism 140, imaging time of the imaging sensor 120, data transfer time, or time required for an inspection of one inspection object that is a total sum of time in which a recognition processing program determines a defect.

The inspection repeatability f4 is reproducibility of the inspection when the same inspection object is repeatedly inspected.

The learning time f5 is time required for learning when a learning-type inspection algorithm is used as the recognition program 161, and is zero when the recognition program 161 uses a non-learning-type inspection algorithm, for example, when the defect is detected by comparing a feature amount in the image with a threshold.

The device cost f6 represents a cost of structuring the inspection system 100.

The operating cost f7 represents a cost of operating the inspection system 100. The operating cost f7 includes an electrical charge and a maintenance charge.

The device robustness f8 is an indication that represents unlikeliness of failure of the inspection system 100.

The inspection versatility f9 is an indication that represents whether the inspection system 100 can be applied to various inspection objects.

The longevity f10 is a longevity of the inspection system 100.

The assemblability f11 is an indication that represents assemblability of the inspection system 100.

The required assembly accuracy f12 is an indication that represents assembly accuracy required for achieving the inspection accuracy and the like. The higher the required assembly accuracy is, the more adverse effect is given to the inspection accuracy by an assembly error and also the more cost is required for assembling the device.

The robustness against environment f13 is an indication that represents whether the inspection result is disguised or the inspection system 100 is failed by its environment such as diplomacy, change in temperature and humidity, and vibration, and the like.

The maintenanceability f14 is an indication that represents easiness of cleaning or adjusting the inspection system 100.

The clarity of ground for the judgement of recognition processing f15 is an indication that represents whether the recognition program 161 of the inspection system 100 is a recognition program capable of explaining the ground for the judgement of the recognition processing. In general, the recognition program using deep learning often lacks the ground for the judgement, which lowers the clarity.

The recognizability of detected portion f16 is an indication that represents whether the recognition program 161 can recognize in which part of the image the defect is located when the recognition program 161 detects the defect. It should be noted that, depending on the type of the recognition engine of the recognition program 161, it may not be possible to recognize in which part of the image the defect is located, in which case the recognizability is lower.

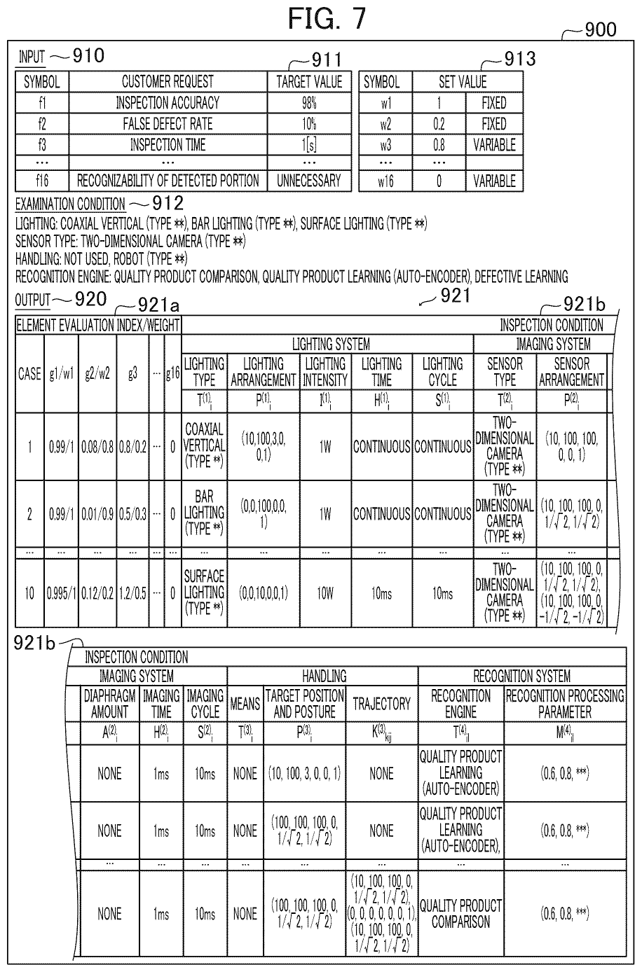

A target value of a customer indication (fi(i=1 to 16)) can be received by, for example, a GUI screen 900 (see FIG. 7) from the user, and the target value of some element evaluation indices of the customer indication may include a qualitative indication. Thus, in the present embodiment, the received customer indication (fi(i=1 to 16)) is quantitated to be converted into a customer indication for comparison (gi(i=1 to 16)) that is comparable.

Then, based on the customer indication for comparison (gi(i=1 to 16)), an indication Ftarget including a plurality of element evaluation indices is generated as shown in Formula (3) to be used for an optimization processing.

$$\begin{matrix}[ Formula 3 ] & \\ Ftarget = {\sum }_{i = 0}^{16} ( wi \times gi ) & ( 3 )\end{matrix}$$

Here, wi is a weight corresponding to each element evaluation index gi. An input of wi may be received via the GUI screen 900, or resetting of wi may be received via the GUI screen 900.

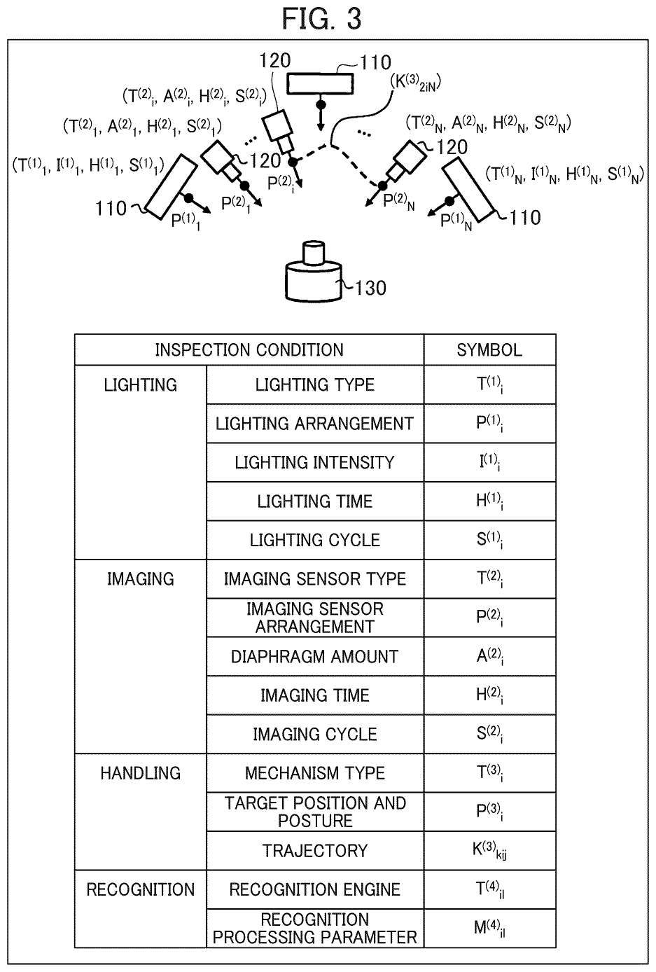

FIG. 3 illustrates the inspection condition according to an embodiment.

The inspection condition of the inspection system 100 includes a condition of lighting (lighting condition), a condition of imaging (imaging condition), a condition of handling (handling condition), and a condition of recognition (recognition condition).

The lighting condition includes lighting type, lighting arrangement, lighting intensity, lighting time, and lighting cycle. The imaging condition includes condition of imaging sensor type, imaging sensor arrangement, diaphragm amount, imaging time, and imaging cycle and the like. The handling condition includes a type of the handling mechanism, a position and posture, and a route to the target position and posture, and the like. The recognition condition includes such conditions as a recognition engine type, a recognition processing parameter, and the like.

In the present embodiment, each condition is represented by symbols shown in FIG. 3. Here, T represents a type of an object to the condition. P represents a three-dimensional position and posture of the object. P corresponds to, for example, a vector (x, y, z, i, j, k) that combines (x, y, z) indicative of the three-dimensional position and a unit vector (x, y, z, i, j, k) indicative of the posture. S represents a cycle associated with the object. H represents time associated with the object. I represents the lighting intensity (e.g., watt), A represents a diaphragm amount of the imaging sensor (power of the diaphragm, e.g., a value of 1 to 0), K represents a trajectory of the handling mechanism 140 (e.g., a set of vectors (x, y, z, i, j, k) of the three-dimensional coordinates of each position on the trajectory and the posture), and M represents a parameter (set of parameters) of the recognition processing.

Suffixes (1) to (4) on the upper right of alphabets represent values associated with lighting, imaging, handling, and recognition, respectively. A suffix i on the lower right of each alphabet represents the number of arrangements of items of the same type. It should be noted that, as for K, the symbol has i and j as the suffix on the lower right, where i indicates a start point and j indicates an end point. As for T and M associated with recognition, the symbol has i and 1 as the suffix on the lower right, where i indicates a portion of the captured image and 1 indicates a number of the recognition processing performed on the image.

In the inspection condition optimization processing by the inspection condition optimization program 212, a combination of appropriate inspection conditions (T, P, S, H, I, A, K, M) is to be calculated on the basis of the indication Ftarget and output. Here, the appropriate inspection condition is determined by the indication to be adopted, which is an inspection condition that satisfies, for example, any one of a gently inclined (stable) local maximum value (stable) and a gently inclined local minimum value in which the value of the indication Ftarget satisfies the minimum, maximum, local minimum, local maximum, and predetermined values.

Next, a processing operation of the inspection condition optimization processing by the computer 200 is described.

First, there is described an inspection condition optimization processing (first inspection condition optimization processing) of optimizing the inspection condition based on an actual inspection result by the inspection system 100.

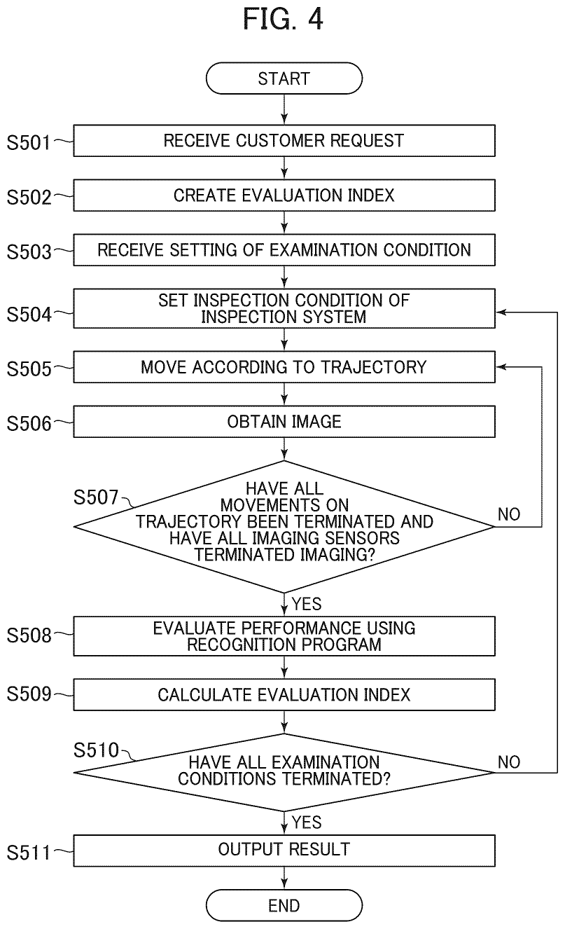

FIG. 4 is a flowchart of a first inspection condition optimization processing according to an embodiment.

The inspection condition optimization program 212 (strictly, the processor 202 that executes the inspection condition optimization program 212) receives the setting of the weight of the customer indication (f1 to f16) corresponding to the customer request, the target value of each element evaluation index, and each element evaluation index via the GUI screen 900 (S501).

The inspection condition optimization program 212 then creates the evaluation index to be used for the processing (Formula (3)) based on the evaluation index for comparison (g1 to g16) corresponding to the customer indication (f1 to f16) and the setting of the weight, and converts the target value of each element evaluation index to the target value of the evaluation index for comparison (target value for comparison) (S502).

The inspection condition optimization program 212 then receives the examination condition to be a constraint condition on the inspection condition in the optimization processing via the GUI screen 900, for example (S503). Here, the examination condition includes, for example, a type of the lighting to be considered, a type of the imaging sensor, a type of the handling mechanism, a type of the recognition engine, and the like.

The inspection condition optimization program 212 then determines the inspection condition to be considered according to the examination condition, where the inspection system 100 is set to comply with the determined inspection condition (objective inspection condition) (S504). It should be noted that the condition may be set by the user of the inspection system 100 if there is any condition that cannot be set by the inspection system 100 itself among the objective inspection conditions.

The inspection condition optimization program 212 then causes the inspection system 100 to drive the handling mechanism 140 according predetermined trajectory (if there is any trajectory condition in the objective inspection condition, the trajectory corresponding to the condition) (S505), and to generate an image of the inspection object 130 according to the objective inspection condition (S506).

The inspection condition optimization program 212 then determines whether all movements on the trajectory have been terminated and all imaging sensors 120 have terminated imaging (S507), and if all movements on the trajectory have been terminated and not all imaging sensors 120 have terminated imaging (S507: NO), the process moves to Step 505. This allows for continuing movements on the trajectory and imaging by the imaging sensor 120.

On the other hand, if all movements on the trajectory have been terminated and all imaging sensors 120 have terminated imaging (S507: YES), the inspection condition optimization program 212 causes the recognition program 211 to evaluate inspection performance using the captured image (S508), and calculates an evaluation index Ftarget based on the result of the performance evaluation and the like (S509).

The inspection condition optimization program 212 then determines whether an evaluation index of the inspection condition corresponding to all of the examination conditions has been calculated (S510), and if the evaluation index of the inspection condition corresponding to all of the examination conditions has not been calculated (S510: NO), the inspection condition optimization program 212 moves to Step S504 to execute the inspection condition including the examination condition for which the evaluation index has not been calculated.

On the other hand, if the evaluation index of the inspection condition corresponding to all of the examination conditions has been calculated (S510: YES), the inspection condition optimization program 212 determines the optimal inspection condition based on the value of the evaluation index by the plurality of inspection conditions and outputs (e.g., displays on the GUI screen 900) the determined result (S511). It should be noted that, at Step S511, although the inspection condition optimization program 212 determines and outputs the optimal inspection condition, the invention is not limited thereto, and it may determine and output an appropriate inspection condition that satisfies a predetermined criterion (e.g., to exceed the target value of the evaluation index).

Next, an inspection condition optimization processing (second inspection condition optimization processing) that optimizes the inspection condition based on the inspection result obtained by simulating an inspection in the inspection system 100 with an optical model is described.

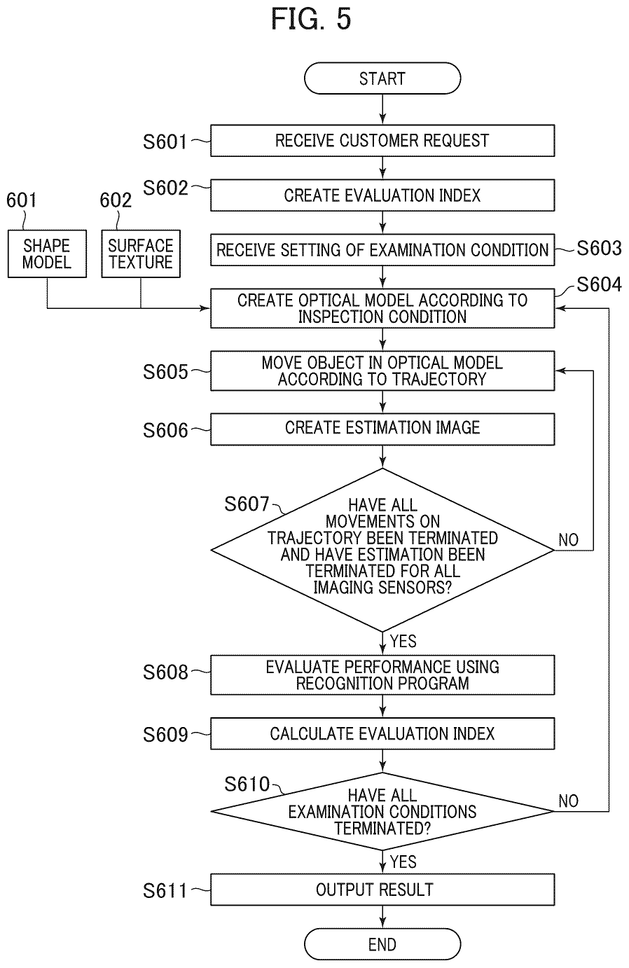

FIG. 5 is a flowchart of a second inspection condition optimization processing according to an embodiment.

The inspection condition optimization program 212 (strictly, the processor 202 that executes the inspection condition optimization program 212) receives the setting of the weight of the customer indication (f1 to f16) corresponding to the customer request, the target value of each element evaluation index, and each element evaluation index via the GUI screen 900 (S601).

The inspection condition optimization program 212 then creates the evaluation index to be used for the processing (Formula (3)) based on the evaluation index for comparison (g1 to g16) corresponding to the customer indication (f1 to f16) and the setting of the weight, and converts the target value of each element evaluation index to the target value of the evaluation index for comparison (target value for comparison) (S602).

The inspection condition optimization program 212 then receives the examination condition to be a constraint condition on the inspection condition in the optimization processing via the GUI screen 900, for example (S603). Here, the examination condition includes, for example, a type of the lighting to be considered, a type of the imaging sensor, a type of the handling mechanism, a type of the recognition engine, and the like.

The inspection condition optimization program 212 then determines the inspection condition to be considered according to the examination condition, and the optical simulation program 213 creates an optical model that represents the state of the inspection of the inspection object 130 in the inspection system 100 based on a shape model 601 (three-dimensional shape model) of the inspection object 130, a surface texture 602 of the inspection object 130, and the inspection condition (S604).

Here, the shape model 601 is a 3D-CAD model that is design information of a product, or mesh or CAD data created from the result of measurement by a three-dimensional shape measuring device. The shape model 601 may be, for example, obtained from the memory 201 of the computer 200, or may be received from the outside. Moreover, the surface texture 602 is information about reflection characteristics of light (surface texture information) determined by minute unevenness not included in the shape model and material, which is expressed by BRDF (Bidirectional Reflectance Distribution Function), may be input by the user, for example, and may be data measured by a surface texture measuring machine. The surface texture 602 may be, for example, obtained from the memory 201 of the computer 200, or may be received from the outside.

The optical simulation program 213 moves an inspection object in the optical model according to a predetermined trajectory (if there is any trajectory condition in the objective inspection condition, the trajectory corresponding to the condition) (S605), and generates an image (estimation image) estimated to be imaged of the inspection object 130 using the optical model (S606).

The inspection condition optimization program 212 then determines whether all movements on the trajectory have been terminated and whether generation of all estimation images estimated to be imaged by the imaging sensor has been terminated (S607), and, if all movements on the trajectory have been terminated and generation of all estimation images estimated to be imaged by the imaging sensor has not been terminated (S607: NO), moves the processing to Step S605. This allows for generation of the estimation image in a case where the trajectory continues to be moved.

On the other hand, if all movements on the trajectory have been terminated and generation of all estimation images estimated to be imaged by the imaging sensor has been terminated (S607: YES), the inspection condition optimization program 212 causes the recognition program 211 to evaluate the inspection performance using the estimation image (S608), and calculates the evaluation index Ftarget based on the result of the performance evaluation and the like (S609).

The inspection condition optimization program 212 then determines whether an evaluation index of the inspection condition corresponding to all of the examination conditions has been calculated (S610), and if the evaluation index of the inspection condition corresponding to all of the examination conditions has not been calculated (S610: NO), the inspection condition optimization program 212 moves to Step S604 to execute the inspection condition including the examination condition for which the evaluation index has not been calculated.

On the other hand, if the evaluation index of the inspection condition corresponding to all of the examination conditions has been calculated (S610: YES), the inspection condition optimization program 212 determines the optimal inspection condition based on the value of the evaluation index by the plurality of inspection conditions and outputs (e.g., displays on the GUI screen 900) the determined result (S611). It should be noted that, at Step S611, although the inspection condition optimization program 212 determines and outputs the optimal inspection condition, the invention is not limited thereto, and it may determine and output an appropriate inspection condition that satisfies a predetermined criterion (e.g., to exceed the target value of the evaluation index).

It should be noted that, although the optimization is performed by comprehensively changing the inspection condition in the inspection condition optimization processing shown in FIGS. 4 and 5, the optimization method is not limited thereto. For example, an efficient search such as an experimental design method or a Bayesian optimization may be performed. For example, a Benders decomposition of searching for an optimum condition by dividing conditions into a condition of a linear portion associated with a device configuration (condition denoted by a symbol T in FIG. 3) and a condition of a non-linear portion (parameter) may be used. Moreover, the lighting type or arrangement, or the type of the recognition engine may be limited on the basis of similar instances in the knowledge database 220. In this case, the similar instances may be found by the user or may be found using a machine-learned matching function.

Next, an optical model calibration processing of calibrating an optical model is described. The optical model calibration processing is performed, for example, before the second inspection condition optimization processing shown in FIG. 5.

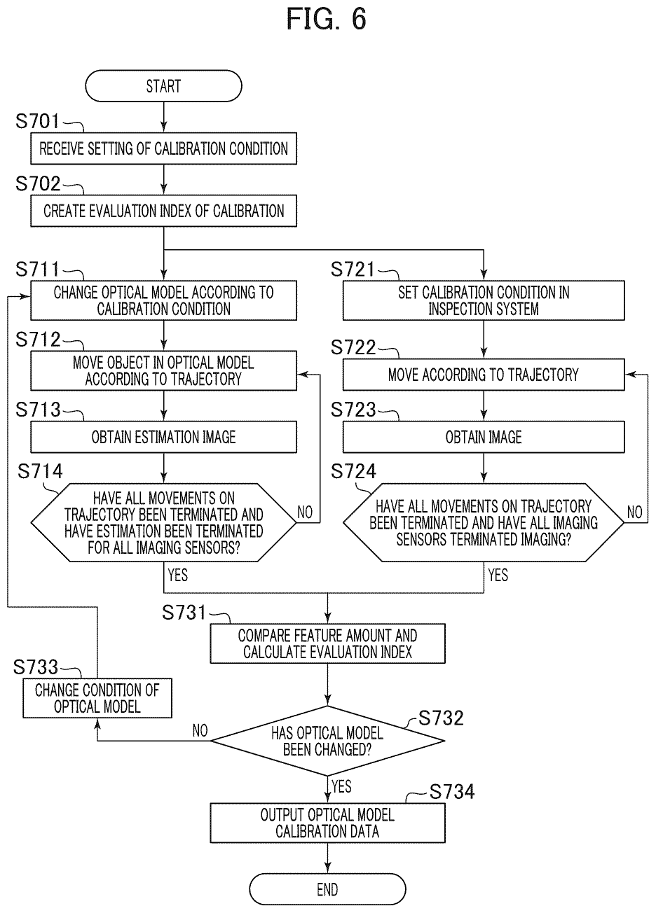

FIG. 6 is a flowchart of an optical model calibration processing according to an embodiment.

The optical model calibration program 214 (strictly, the processor 202 that executes the optical model calibration program 214) receives settings of the calibration condition including an inspection condition of the inspection system 100 used for the calibration (e.g., the current inspection condition of the inspection system 100) and an optical model changing condition (e.g., a range of changing reflectance of the inspection object (0.2 to 0.8, or the like)) from the user via the GUI screen (S701).

The optical model calibration program 214 then creates an evaluation index in the calibration (calibration evaluation index) (S702). Here, the calibration evaluation index is a function combining feature amounts to be compared in the calibration, and may be, for example, an average value or a sum of dispersion of differences between an estimation image to be described later and an obtained image with respect to each pixel. The calibration evaluation index may be compliant with a user definition, or may be selected or generated on the basis of an instance.

The optical model calibration program 214 then performs a processing of obtaining an estimation image using the optical model (S711 to S714) and a processing of actually obtaining an image by the inspection system 100 (S721 to S724).

In the processing of obtaining an estimation image using the optical model (S711 to S714), the optical model calibration program 214 first determines a condition of the optical model to be considered on the basis of the calibration condition (e.g., a predetermined value in the range of changing reflectance of the inspection object), and the optical simulation program 213 creates an optical model that indicates the state of the inspection of the inspection object 130 in the inspection system 100 based on the setting condition in the calibration condition and the determined condition of the optical model (S711).

The optical simulation program 213 moves an inspection object in the optical model according to a predetermined trajectory (if there is any trajectory condition in the objective inspection condition, the trajectory corresponding to the condition) (S712), and generates an image (estimation image) estimated to be imaged of the inspection object 130 using the optical model (S713).

The optical model calibration program 214 then determines whether all movements on the trajectory have been terminated and whether generation of all estimation images estimated to be imaged by the imaging sensor has been terminated (S714), and, if all movements on the trajectory have been terminated and generation of all estimation images estimated to be imaged by the imaging sensor has not been terminated (S714: NO), moves the processing to Step S712. This allows for generation of the estimation image in a case where the trajectory continues to be moved.

On the other hand, if all movements on the trajectory have been terminated and generation of all estimation images has been terminated (S714: YES), the optical model calibration program 214 proceeds the process to Step S731.

In the processing of actually obtaining an image by the inspection system 100 (S721 to S724), the optical model calibration program 214 first sets the inspection system 100 to be compliant with the inspection condition (objective inspection condition) included in the calibration condition (S721). It should be noted that the condition may be set by the user of the inspection system 100 if there is any condition that cannot be set by the inspection system 100 itself among the objective inspection conditions.

The optical model calibration program 214 then causes the inspection system 100 to drive the handling mechanism according to a predetermined trajectory (if there is any trajectory condition in the objective inspection condition, the trajectory corresponding to the condition) (S722), and to generate an image of the inspection object 130 (actual image) according to the objective inspection condition (S723).

The optical model calibration program 214 then determines whether all movements on the trajectory have been terminated and all imaging sensors have terminated imaging (S724), and if all movements on the trajectory have been terminated and not all imaging sensors 120 have terminated imaging (S724: NO), the process moves to Step 722. This allows for continuing movements on the trajectory and imaging by the imaging sensor.

On the other hand, if all movements on the trajectory have been terminated and all imaging sensors 120 have terminated imaging (S724: YES), the optical model calibration program 214 proceeds the processing to Step S731.

At Step S731, the optical model calibration program 214 compares feature amounts between the estimation image and the actual image, and calculates the calibration evaluation index for the optical model used.

The optical model calibration program 214 then determines whether changes have been made for all the optical models that correspond to the changing condition included in the calibration condition (S732).

As a result, if the changes are not made for all the optical models (S732: NO), the optical model calibration program 214 changes the condition of the optical model based on the changing condition (S733), proceeds the processing to Step S711, and performs a processing of obtaining the estimation image for another optical model.

On the other hand, if the changes are made for all the optical models (S732: YES), the optical model calibration program 214 specifies a parameter of the optical model appropriately indicative of the inspection about the inspection object (e.g., the reflectance of the inspection object) based on the evaluation index, and outputs the parameter of the optical model as calibration data (S734). Here, the parameter of the optical model appropriately indicative of the inspection is determined by the calibration evaluation index adopted, which is a parameter that satisfies, for example, any one of a gently inclined (stable) local maximum value (stable) and a gently inclined local minimum value in which the value of the calibration evaluation index satisfies the minimum, maximum, local minimum, local maximum, and predetermined values.

It should be noted that, when the second inspection condition optimization processing shown in FIG. 5 is performed thereafter, the optical simulation program 213 generates the optical model based on the calibration data, and can generate the optical model conformed to the inspection state in the actual inspection system 100 to generate the estimation image with high accuracy.

Next, the GUI screen 900 is described.

FIG. 7 shows a GUI screen according to an embodiment.

The GUI screen 900 includes an input area 910 and an output area 920. The input area 910 includes a customer request input area 911, an examination condition input area 912, and an weight input area 913.

The customer request input area 911 is an area to input the customer request, which includes fields of a symbol indicative of an element evaluation index for the customer request, a customer request indicative of a content of the element evaluation index, and a target value to input the target value of the element evaluation index. Here, by setting unnecessary to the target value, it is possible to set an evaluation index without consideration of the corresponding element evaluation index. That is, it is possible not to consider the value of the corresponding element evaluation index in Formula (3).

The examination condition input area 912 is an area to input a condition to be examined for the inspection condition in the inspection system 100 (examination condition).

The weight input area 913 is an area to input a weight value corresponding to a value of each element evaluation index. It should be noted that, in the weight input area 913, it is possible to input the weight value and a setting of whether the weight value is a fixed value or a variable value.

The output area 920 displays a processing result list 921. The processing result list 921 includes an entry of the appropriate inspection condition detected in the inspection condition optimization processing. For example, if weights wi of all the element evaluation indices are input as the fixed values, a single entry is displayed, and if the weights wi of all the element evaluation indices are input as variable values, an entry of the corresponding appropriate inspection condition is displayed with respect to each set of the weights of the element evaluation indices.

An entry to the processing result list 921 includes fields of an element evaluation index/weight 921a and an inspection condition 921b. The element evaluation index/weight 921a displays a value of each element evaluation index and a value of a weight of the element evaluation index. The inspection condition 921b stores therein a value of each inspection condition of the inspection system 100 (inspection object information).

Although the above description shows an example of inspecting the inspection object 130 as an integral body, the inspection object 130 may possibly have different appropriate lightings, imaging sensors, or recognition programs with respect to each portion of the inspection object depending its shape or surface texture. For example, if the inspection object is a portion cut out of a casting, the surface texture is different between a portion with a casted surface and a cut portion exhibiting markedly different image features. Thus, changing the lighting type, the lighting angle, or lighting intensity, or changing a parameter of the recognition program may lead to improved success rate of the inspection.

Therefore, the inspection may be conducted by dividing the inspection area of the inspection object 130 into a plurality of portions. A case of inspecting a plurality of divided inspection areas is described below.

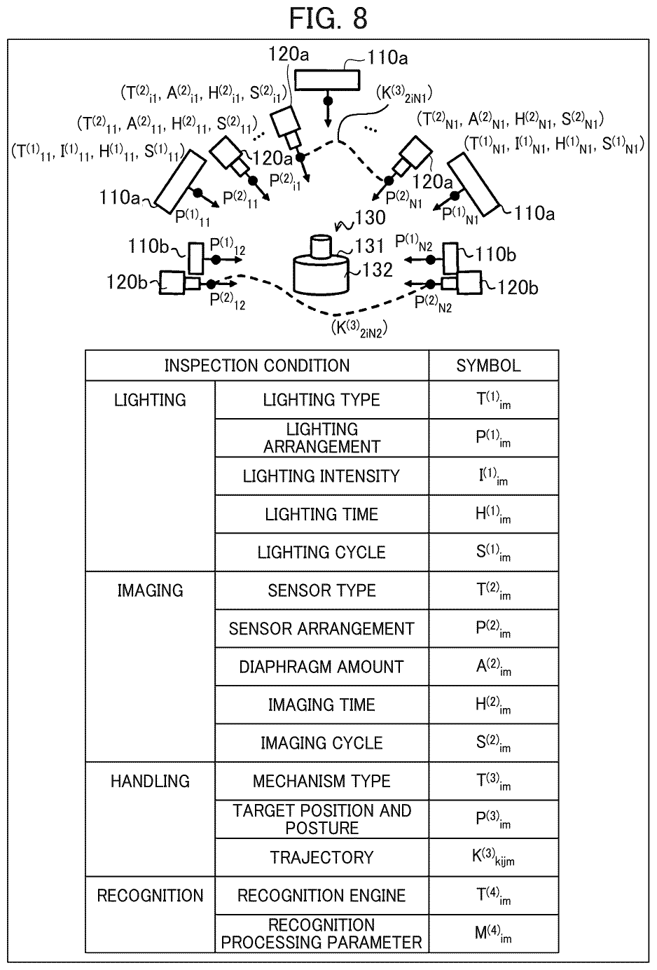

FIG. 8 illustrates the inspection condition when dividing an inspection area according to an embodiment. It should be noted that FIG. 8 is an example of inspecting the inspection object 130 by dividing it into a top plane 131 and a cylindrical surface 132, and the plane 131 is an example case of an inspection by imaging with a lighting 110a and an imaging sensor 120a and the cylindrical surface 132 is an example case of an inspection by imaging with a lighting 110b and an imaging sensor 120b.

The inspection condition of the inspection system 100 includes a condition of lighting (lighting condition), a condition of imaging (imaging condition), a condition of handling (handling condition), and a condition of recognition (recognition condition).

The lighting condition includes lighting type, lighting arrangement, lighting intensity, lighting time, and lighting cycle. The imaging condition includes condition of imaging sensor type, imaging sensor arrangement, diaphragm amount, imaging time, and imaging cycle and the like. The handling condition includes a type of the handling mechanism, a position and posture, and a route to the target position and posture, and the like. The recognition condition includes such conditions as a recognition engine type, a recognition processing parameter, and the like.

Each condition is denoted by symbols shown in FIG. 8. As for the symbols, only differences from those symbols shown in FIG. 3 are described here.

There is added an m as a suffix at the lower right of the alphabet. The symbol m is a number indicative of a case of the inspection object (inspection object area). In this example, when the face of the inspection object is plane 131, m is 1 and when the face of the inspection object is cylindrical surface 132, m is 2.

Next, the inspection condition optimization processing in a case of an inspection by dividing the inspection object 130 into a plurality of portions is described.

First, the inspection condition optimization program 212 determines a division plan for dividing the inspection object 130 into a plurality of inspection areas (partial inspection areas) based on a machining condition of the inspection object 130 (division plan determination step).

The inspection condition optimization program 212 then performs the inspection condition optimization processing shown in either FIG. 4 or 5 on each of the inspection areas in the division plan and determines the optimal inspection condition, and also calculates an overall evaluation index value (division plan evaluation index value) at the time of division by summing the evaluation index values of respective inspection areas (division plan evaluation index calculation step).

Then, by performing the division plan determination step and the division plan evaluation index calculation step, the inspection condition optimization program 212 determines the inspection condition for a plurality of division plans for the inspection object 130 and calculates respective division plan evaluation index values.

The inspection condition optimization program 212 then determines an appropriate (e.g., optimal) division plan and inspection condition that satisfy a predetermined condition based on the division plan evaluation indices of a plurality of division plan, and outputs the determination result.

According to this processing, it is possible to determine an appropriate division plan of the inspection object 130 and an appropriate inspection condition with respect to each inspection area in the division plan.

Now, a change in an inspection image of the inspection object targeted by the inspection system 100 over time is described.

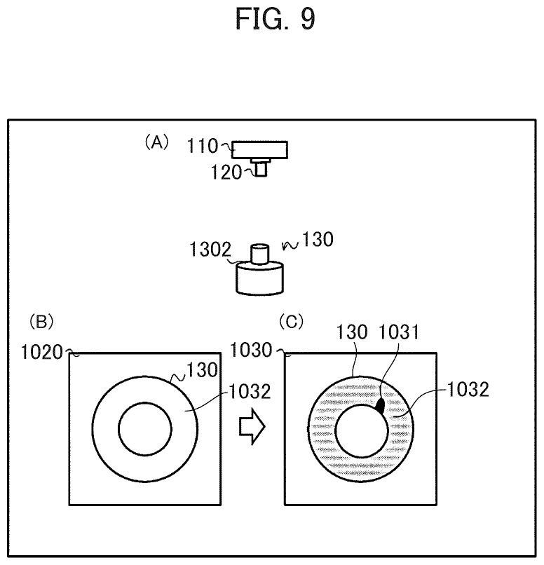

FIG. 9 illustrates a change in an inspection image according to an embodiment. FIG. 9(A) shows a state of imaging the inspection object, FIG. 9(B) shows an inspection image immediately after start of an operation of the inspection system 100, and FIG. 9(C) shows an inspection image after some time has passed since the start of the operation of the inspection system 100.

In the inspection system 100, as shown in FIG. 9(A), imaging is performed by the imaging sensor 120 with the lighting 110 from above the inspection object 130.

Immediately after the start of the operation of the inspection system 100, the inspection image of the inspection object 130 is in a state of clearly imaging the inspection object 130 as shown in FIG. 9(B).

After this, if the inspection system 100 continues its operation and, for example, a lens of the imaging sensor 120 is damaged, the inspection image of the inspection object 130 may include a damage 1031, for example, as shown in FIG. 9(C). Moreover, if there is any stain or the like on the lens, the whole image may possibly become darker. Furthermore, even if the same inspection object 130 is used, shade or brightness of a surface 1032 of the inspection object 130 may also possibly change due to the change in a material used for manufacturing the inspection object 130 with a lapse of time.

In such a state, the inspection condition in the inspection system 100 may not be the optimal inspection condition any more.

Therefore, the inspection system 100 according to the present embodiment performs a processing of redetermining the inspection condition in such a case (inspection condition redetermination processing).

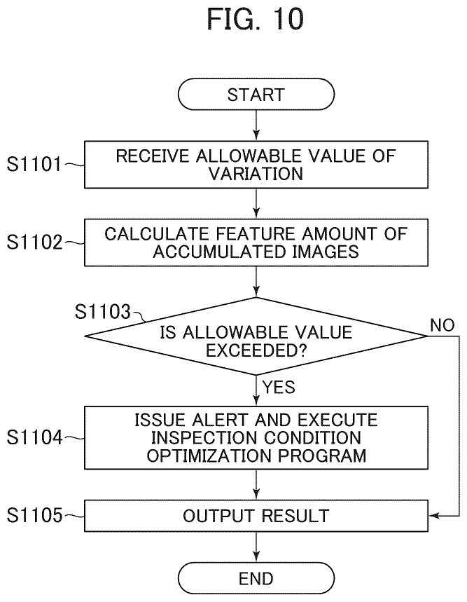

FIG. 10 is a flowchart of an inspection condition redetermination processing according to an embodiment.

The inspection image change detection program 215 receives an allowable value for variation of a feature amount in the inspection image (S1101). Here, the feature amount may be a static such as a luminance average and a luminance variance in a predetermined area of the inspection image or the inspection image. Moreover, the allowable value may be received from the user at the time of starting the operation of the inspection system 100 or after every predetermined number of inspections. The allowable value may also be a default value.

The inspection image change detection program 215 then calculates the feature amount in the image based on the inspection images of the inspection object imaged by and stored in the inspection system 100 (S1102).

The inspection image change detection program 215 then determines whether the calculated feature amount exceeds the allowable value or not (S1103).

As a result, if the calculated feature value exceeds the allowable value (S1103: YES), the inspection image change detection program 215 causes the inspection condition optimization processing shown in FIG. 4 or 5 by issuing an alert and executing the inspection condition optimization program 212 (S1104), and the inspection image change detection program 215 outputs the result (S1105). It should be noted that, when performing the inspection condition optimization processing in the inspection condition redetermination processing, some of the inspection conditions such as the lighting type, the image sensor type, and the handling mechanism among the inspection conditions may be fixed to the current state. In this manner, the configuration of the inspection system 100 already in use can be used as the inspection condition as it is, and occurrence of an additional investment for the inspection system 100 can be prevented.

On the other hand, if the calculated feature value does not exceed the allowable value (S1103: NO), the inspection image change detection program 215 outputs the result that there is no need of performing the inspection condition optimization processing (S1105).

Next, an example of optimizing various conditions in the manufacturing process including a plurality of machining processes and a plurality of inspection processes by the computer 200 is described.

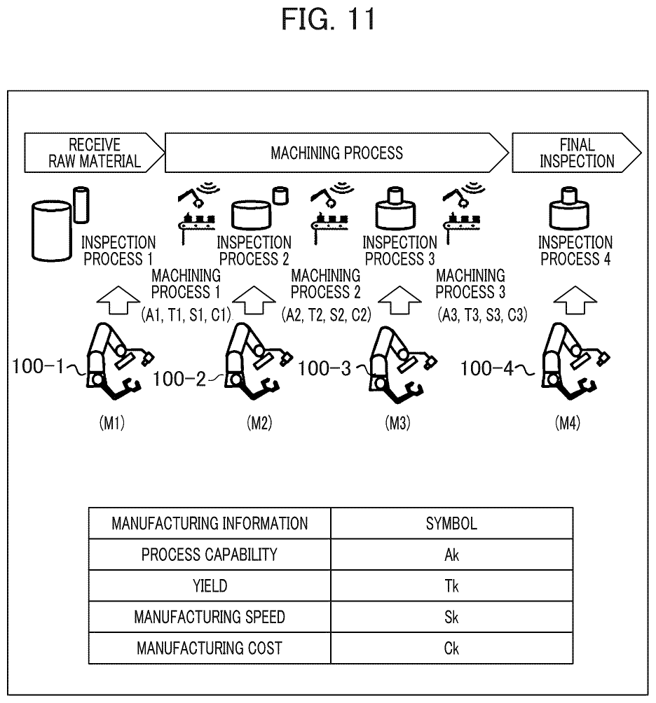

FIG. 11 illustrates a manufacturing process according to an embodiment.

This manufacturing process includes an inspection process 1, a machining process 1, an inspection process 2, a machining process 2, an inspection process 3, a machining process 3, and an inspection process 4. Raw materials received by an inspection system 100-1 are inspected in the inspection process 1, workpieces machined by an inspection system 100-2 in the machining process 1 are inspected in the inspection process 2, the workpieces machined by an inspection system 100-3 in the machining process 2 are inspected in the inspection process 3, and the workpieces machined by an inspection system 100-4 in the machining process 3 are inspected in the inspection process 4. Here, as information about manufacturing in the machining process (manufacturing information), a process capability is denoted by Ak, a yield is denoted by Tk, a manufacturing speed is denoted by Sk, and a manufacturing cost is denoted by Ck. It should be noted that k indicates the process number of the machining process.

The inspection condition optimization processing by the multi-system inspection condition optimization program 216 in this example is described. It should be noted that differences in processing between the multi-system inspection condition optimization program 216 and the inspection condition optimization program 212 are described here with reference to FIG. 3 (FIG. 4) for convenience. Moreover, it is assumed that the process capability Ak, the yield Tk, the manufacturing cost Sk, and the manufacturing cost Ck for each machining process have been known or considered and set or entered.

t Step S501 (S601), the multi-system inspection condition optimization program 216 receives the setting of the weight (Wij) for a customer indication fij (i=1 to 16, j is the process number of the inspection process, i=1 to 4 in the example shown in FIG. 11) corresponding to the customer request in the inspection system 100, a target value, and each element evaluation index in the customer request via the GUI screen. Moreover, the multi-system inspection condition optimization program 216 receives the setting of the weight (Wi) for an overall customer indication Fi (i=1 to 16) corresponding to the customer request in the whole inspection process, the target value, and each element evaluation index in the overall customer request.

At Step S502 (S602), the multi-system inspection condition optimization program 216 calculates an evaluation index for comparison gij corresponding to the customer indication fij (i=1 to 16, i=1 to 4), calculates an evaluation index for comparison Gi corresponding to the overall customer indication Fi (i=1 to 16), creates an evaluation index (Formula (4)) used for processing taking into consideration the inspection process and the machining process, and converts the target values of the customer indication and the overall customer indication into the target values of the evaluation indices for comparison (target values for comparison).

$$\begin{matrix}[ Formula 4 ] & \\ Ftarget = {\sum }_{j} ( {\sum }_{i = 1}^{16} ( wij \times gij ) ) + {\sum }_{i = 1}^{16} Wi \times Gi + {\sum }_{k} ( wak \times Ak + wtk \times Tk + wsk \times Sk + wck \times Ck ) & ( 4 )\end{matrix}$$

Here, wak, wtk, wsk, and wck are weights of the process capability Ak, the yield Tk, the manufacturing cost Sk, and the manufacturing cost Ck, respectively. It should be noted that, although the evaluation index is a linear sum of the evaluation index of each machining process and information about a manufacturing situation in the machining process in Formula (4), the present invention is not limited thereto, and the evaluation index may be, for example, a product or a sum of inverse numbers of each indication.

At Step S511 (S611), the multi-system inspection condition optimization program 216 determines the optimal inspection condition based on the value of the evaluation index (Formula (4)) by the plurality of inspection conditions, and outputs the determined result.

According to the processing of optimizing the condition in this manufacturing process, since the customer request with respect to the inspection process and information about the machining process are integrated into a single evaluation index, it is possible to determine an appropriate inspection condition in the whole manufacturing process.

It should be noted that the present invention is not limited to the above-described embodiments but can be modified as appropriate for implementation without departing from the spirit of the invention.

For example, although the optimal inspection condition is determined in the above-mentioned embodiment, the present invention is not limited thereto, and an inspection condition that satisfies a predetermined condition may be determined instead of the optimal inspection condition.

Moreover, although the computer 200 is allowed to perform the inspection condition optimization processing shown in FIGS. 3 and 4 in the above-mentioned embodiment, the inspection condition optimization processing shown in either one figure may be allowed to be performed.

Moreover, although the computer 150 and the computer 200 are different computers in the above-mentioned embodiment, for example, a function of the computer 200 may be integrated into the computer 150.

Furthermore, a part or all of the processing performed by the processor in the above-mentioned embodiment may be performed by a hardware circuit. Moreover, the program in the above-mentioned embodiment may be installed from a program source. The program source may be a program distribution server or a recording medium (e.g., a portable recording medium).

### LIST OF REFERENCE SIGNS

100: inspection system, 150: computer, 200: computer, 201: memory, 202: processor, 203: input device, 204: display device, 211: recognition program, 212: inspection condition optimization program, 213: optical simulation program, 214: optical model calibration program, 215: inspection image change detection program, 216: multi-system inspection condition optimization program

1. An inspection condition determination system that includes a processor and determines an inspection condition in an inspection performed on a predetermined inspection object by the inspection system,
wherein the processor:
receives an input of a user request regarding at least two or more element evaluation indices among an inspection accuracy, a false rate, an inspection time, an inspection repeatability, a learning time, a device cost, an operating cost, a device robustness, an inspection versatility, a longevity, an assemblability, a required assembly accuracy, a robustness against environment, a maintenanceability, a clarity of ground for the judgement of recognition processing, and a recognizability of detected portion, and a target of the element evaluation indices about the inspection in the inspection system;
creates an evaluation index based on the plurality of element evaluation indices about the inspection in the inspection system on the basis of the user request; and
evaluates the inspection result under a plurality of inspection conditions by the evaluation index, and determines an appropriate inspection condition from among the plurality of inspection conditions.

2. The inspection condition determination system according to claim 1,
wherein the processor:
displays inspection object information about the determined inspection condition.

3. The inspection condition determination system according to claim 2,
wherein the evaluation index is an indication that combines the plurality of element evaluation indices adjusted by the weight.

4. The inspection condition determination system according to claim 3,
wherein the processor:
adjusts the weigh;
evaluates the inspection result under the plurality of inspection conditions by the evaluation index with its weight adjusted and determines an appropriate inspection condition from among the plurality of inspection conditions; and
displays the inspection condition and a value of an element evaluation index corresponding to the inspection condition.

5. The inspection condition determination system according to claim 4,
wherein the inspection condition determination system receives adjustment of the weight from the user.

6. The inspection condition determination system according to claim 1,
wherein the inspection system includes a lighting that emits light to the inspection object, an imaging sensor that images the inspection object, and a handling mechanism that adjusts relative positions of the inspection object and the imaging sensor, and
wherein the inspection condition is
at least part of a lighting type, a lighting arrangement, a lighting intensity, a lighting time, a lighting cycle, an imaging sensor type, imaging an sensor arrangement, a diaphragm amount, an imaging time, an imaging cycle, a handling mechanism type, a target position and posture, a trajectory, a recognition engine, and a recognition processing parameter.

7. The inspection condition determination system according to claim 6,
wherein the inspection condition includes at least one of the imaging sensor type, the imaging sensor arrangement, the diaphragm amount, the imaging time, and the imaging cycle, and at least one of the handling mechanism type, the target position and posture, and the trajectory.

8. The inspection condition determination system according to claim 1,
wherein the inspection system includes a lighting that emits light to the inspection object and an imaging sensor that images the inspection object, and
wherein the processor:
creates an optical model about an inspection state of the inspection object based on a three-dimensional shape model of the inspection object, surface texture information of the inspection object, an inspection condition about the lighting, and an inspection condition about the imaging sensor;
creates an estimation image estimated to be imaged by the imaging sensor based on the optical model; and
evaluates the evaluation index in the inspection result using the estimation image and determines an appropriate inspection condition from among the plurality of inspection conditions.

9. The inspection condition determination system according to claim 8,
wherein the processor:
receives an input of the three-dimensional shape model and the surface texture information.

10. The inspection condition determination system according to claim 8,
wherein the processor:
obtains an actual image imaged by the inspection system under the same inspection condition as when the estimation image is created; and
specifies a feature amount in the estimation image and the actual image and calibrates the optical model based on the feature amount.

11. The inspection condition determination system according to claim 1,
wherein the processor:
creates a plurality of division plans of dividing an inspection area of the inspection object into a plurality of partial inspection areas;
evaluates the plurality of partial inspection areas by the evaluation indices of the plurality of inspection conditions for each division plan and determines an appropriate inspection condition from among the plurality of inspection conditions; and
determines an appropriate division plan from among the plurality of division plans.

12. The inspection condition determination system according to claim 1,
wherein the processor:
obtains an actual image imaged by the inspection system by the determined inspection condition, determines whether the inspection result by the inspection result satisfies a target of the element evaluation index in the user request, issues an alert when the target is not satisfied, evaluates a new inspection result by the plurality of inspection conditions based on the evaluation index, and determines an appropriate inspection condition from among the plurality of inspection conditions.

13. The inspection condition determination system according to claim 1,
wherein the processor:
obtains a plurality of actual images imaged by the inspection system by the determined inspection condition, determines whether a feature amount of the plurality of actual images exceeds a predetermined allowable value, issues an alert when the feature amount exceeds the allowable value, evaluates a new inspection result by the plurality of inspection conditions based on the evaluation index, and determines an appropriate inspection condition from among the plurality of inspection conditions.

14. The inspection condition determination system according to claim 1,
wherein the processor:
receives an input of the user request for each of the plurality of inspection systems;
creates an evaluation index based on the plurality of element evaluation indices about the inspection in the inspection system on the basis of the user request; and
evaluates the inspection result under a plurality of inspection conditions by the evaluation index and determines an appropriate inspection condition from among the plurality of inspection conditions.

15. The inspection condition determination system according to claim 14,
wherein the plurality of inspection systems are used in a plurality of inspection processes in the manufacturing process, and
wherein the processor:
further receives an input of a user request regarding at least two or more element evaluation indices among an inspection accuracy, a false defect rate, an inspection time, an inspection repeatability, a learning time, a device cost, an operating cost, a device robustness, an inspection versatility, a longevity, an assemblability, a required assembly accuracy, a robustness against environment, a maintenanceability, a clarity of ground for the judgement of recognition processing, and a recognizability of detected portion and a target of the element evaluation indices about the inspection in the plurality of whole inspection systems; and
creates an evaluation index about manufacturing and inspection in the manufacturing process based on at least one piece of manufacturing information among the process capability, the yield, the manufacturing speed, and the manufacturing cost of the manufacturing process, element evaluation indices about the plurality of whole inspection systems, and an element evaluation index of each inspection system, evaluates an inspection result and a manufacturing situation under a plurality of inspection conditions based on the evaluation index, and determines an appropriate inspection condition from among the plurality of inspection conditions.
